(19) United States
(12) Patent Application Publication
(10) Pub. No.: US 2020/0118237 A1
(43) Pub. Date: Apr. 16, 2020

(54) USAGE MANAGEMENT DEVICE, METHOD OF MANAGING USAGE, AND RECORDING MEDIUM

(71) Applicants: TOYOTA JIDOSHA KABUSHIKI KAISHA, Toyota-shi (JP); NOMURA RESEARCH INSTITUTE, LTD., Tokyo (JP)

(72) Inventors: Daiki KANEICHI, Nisshin-shi (JP); Naoya SUGITA, Kawasaki-shi (JP)

(73) Assignees: TOYOTA JIDOSHA KABUSHIKI KAISHA, Toyota-shi (JP); NOMURA RESEARCH INSTITUTE, LTD., Tokyo (JP)

(21) Appl. No.: 16/571,486

(22) Filed: Sep. 16, 2019

(30) Foreign Application Priority Data
Oct. 10, 2018 (JP) 2018-192080

(51) Int. Cl. G06Q 50/30; G07C 5/00

(52) U.S. Cl. CPC G06Q 50/30; G07C 5/008

(57) ABSTRACT

A usage management device, includes: a control unit to receive usage request information and availability information from a moving object which communicates with outside, the usage request information being for requesting a use of the moving object and being transmitted from a requester, who provides a service using the moving object, to the moving object, the availability information including information which indicates permission or non-permission of the use of the moving object and is transmitted from the moving object to the requester on a basis of the usage request information, and store the usage request information and the availability information in association with each other in a storage unit.

### CROSS-REFERENCE TO RELATED APPLICATION(S)

The present application claims priority to and incorporates by reference the entire contents of Japanese Patent Application No. 2018-192080 filed in Japan on Oct. 10, 2018.

### BACKGROUND

The present disclosure relates to a usage management device, a method of managing usage, and a recording medium.

In the related art, there has been considered a method of effectively using a vehicle in which the same vehicle is mutually exchanged between a plurality of businesses (business companies) such as a business that provides a car sharing service (hereinafter referred to as car sharing business or the like) and a car rental business. For example, Japanese Laid-open Patent publication No. 2017-102553 discloses a technique in which vehicle management data regarding a rental status and reservation of a vehicle is stored in advance in each of a vehicle management database of a car sharing management server and a vehicle management database of a car rental management server, and in a case where a user cannot reserve the vehicle as a result of inquiring availability of the vehicle to the car sharing management server to use the car sharing service, the car rental management server is referred to so that availability of the vehicle is notified to the user if the vehicle is available for reservation.

### SUMMARY

There is a need for providing a usage management device, a method of managing usage, and a recording medium storing program capable of appropriately managing a usage status of a moving object when each of a plurality of requesters that provides a predetermine service requests use of the same moving object.

According to an embodiment, a usage management device, includes: a control unit to receive usage request information and availability information from a moving object which communicates with outside, the usage request information being for requesting a use of the moving object and being transmitted from a requester, who provides a service using the moving object, to the moving object, the availability information including information which indicates permission or non-permission of the use of the moving object and is transmitted from the moving object to the requester on a basis of the usage request information, and store the usage request information and the availability information in association with each other in a storage unit.

According to an embodiment, a method of managing usage performed by a usage management device that manages a usage status of a moving object which communicates with outside, includes: receiving usage request information and availability information from the moving object, the usage request information being for requesting a use of the moving object and being transmitted from a requester, who provides a service using the moving object, the availability information including information which indicates permission or non-permission of the use of the moving object and is transmitted from the moving object to the requester on a basis of the usage request information; and storing, in a storage unit, the usage request information and the availability information in association with each other.

According to an embodiment, a non-transitory computer readable recording medium stores a program for causing a computer to manage a usage status of a moving object which communicates with outside, the program causing a computer to execute functions of: receiving usage request information and availability information from the moving object, the usage request information being for requesting a use of the moving object and being transmitted from a requester, who provides a service using the moving object, the availability information including information which indicates permission or non-permission of the use of the moving object and is transmitted from the moving object to the requester on a basis of the usage request information; and storing, in a storage unit, the usage request information and the availability information in association with each other.

### BRIEF DESCRIPTION OF THE DRAWINGS

FIG. 1 is a schematic diagram illustrating a usage management system to which a usage management device according to an embodiment of the present disclosure can be applied;

FIG. 2 is a block diagram schematically illustrating a configuration of a management server according to the embodiment of the present disclosure of FIG. 1;

FIG. 3 is a block diagram schematically illustrating a configuration of a business server of FIG. 1;

FIG. 4 is a block diagram schematically illustrating a configuration of a vehicle of FIG. 1;

FIG. 5 is a block diagram schematically illustrating a configuration of a user terminal device of FIG. 1;

FIG. 6 is a flowchart illustrating a process flow of a method of managing usage according to the embodiment of the present disclosure; and

FIG. 7 is a schematic diagram illustrating the method of managing usage according to the embodiment of the present disclosure.

### DETAILED DESCRIPTION

In the related art, information owned and managed by each of the plurality of businesses (e.g., business companies) providing the service such as the car sharing service and the car rental service is not normally shared between the businesses. That is, there has been a problem that a status of a moving object can be realized only while the moving object is used in the service provided by the business, as each of the businesses manages a usage status of the moving object, such as a vehicle, using its own terminal. Accordingly, in a case where the same moving object is used in a plurality of services, it has been difficult to appropriately manage the usage status of the moving object even if each of the businesses acts as a requester that requests use of the same moving object and tries to share the same moving object for the service to be provided. In view of the above, in a situation where a method of using the moving object becomes diversified, a technique by which each usage status of the moving object can be appropriately understood and managed in an environment where a plurality of requesters requests use of the same moving object to provide each service has been desired.

Hereinafter, an embodiment of the present disclosure will be described with reference to the accompanying drawings. Note that the same or corresponding parts are denoted by the same reference signs in all the drawings of the following embodiment. In addition, the present disclosure is not limited by the embodiment to be described below.

Usage Management System

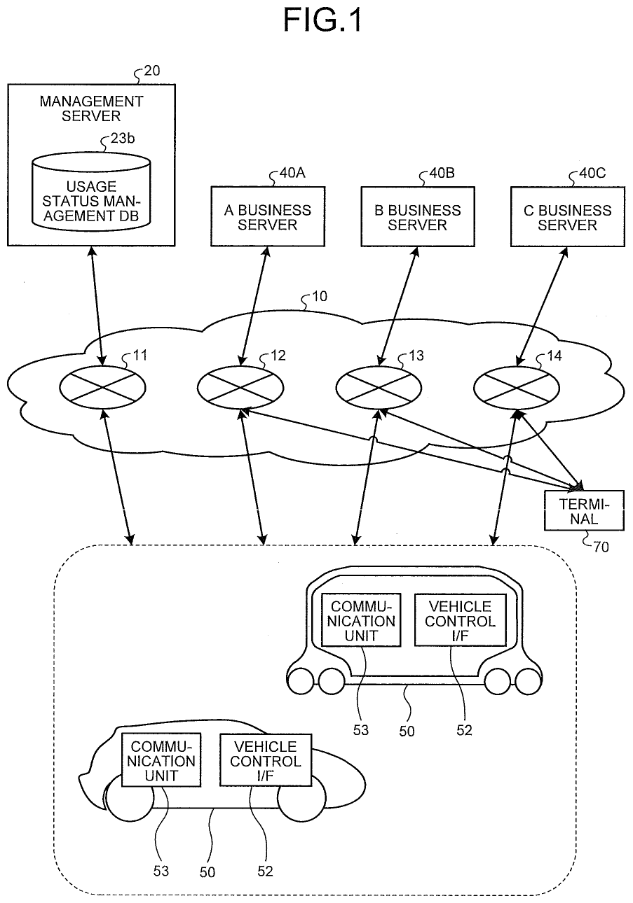

First, a usage management system to which a usage management device according to the embodiment of the present disclosure can be applied will be described. FIG. 1 is a schematic diagram illustrating a usage management system 1 to which the usage management device according to the present embodiment can be applied. As illustrated in FIG. 1, the usage management system 1 according to the embodiment includes a management server 20, a business servers 40A, 40B, and 40C, a vehicle 50 including a vehicle control interface (I/F) 52 and a communication unit 53, and a user terminal device (hereinafter may be simplified as a “terminal”) 70. The management server 20 is capable of communicating with a plurality of vehicles 50 via a network 11. The respective business servers 40A, 40B, and 40C are capable of communicating with the plurality of vehicles 50 and the user terminal device 70 via networks 12, 13, and 14.

Each of the networks 11 to 14 includes the Internet network, a mobile phone network or the like. Each of the networks 11 to 14 is, for example, a public communication network such as the Internet, and may include a wide area network (WAN), a telephone communication network such as a mobile phone, and another communication network such as a wireless communication network such as Wi-Fi. The networks 11 to 14 constitute a wide area network 10 as a whole. Note that the networks 11 to 14 may be collectively referred to as the network 10 in the following descriptions.

Management Server

The management server 20 as a usage management device manages an operation status and a usage status of the vehicle 50. In the present embodiment, various kinds of operation information and vehicle information are supplied from each vehicle 50 to the management server 20 at a predetermined timing. The operation information includes information associated with the operation of the vehicle 50, such as positional information, speed information, and acceleration information, but is not necessarily limited to those pieces of information. The vehicle information includes information associated with a status of the vehicle 50, such as a battery charge amount (or state of charge (SOC)), a fuel remaining amount, the current position, an in-car state, and an exterior state, but is not necessarily limited to those pieces of information.

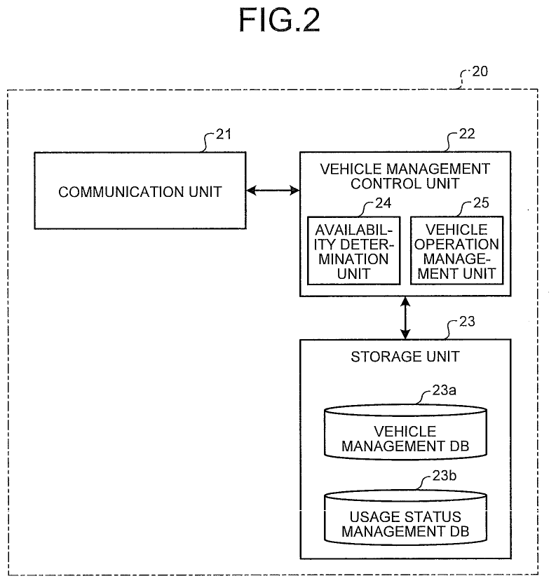

FIG. 2 is a block diagram schematically illustrating a configuration of the management server 20. As illustrated in FIG. 2, the management server 20 has a general computer configuration that can communicate via the network 11. The management server 20 includes a communication unit 21, a vehicle management control unit 22, and a storage unit 23.

The communication unit 21 as an information acquisition unit is, for example, a local area network (LAN) interface board, or a wireless communication circuit for wireless communication. The LAN interface board and the wireless communication circuit are connected to the network 11 such as the Internet that is a public communication network. The communication unit 21 is connected to the network 11 to communicate with the vehicle 50. The communication unit 21 receives, from each vehicle 50, various kinds of information such as vehicle identification information that is moving object identification information unique to the vehicle 50, operation status information related to operation of the vehicle 50, usage request information related to a request for use of the vehicle 50, usage information indicating a usage status of the vehicle 50, and determination request information. Note that the vehicle identification information includes information for enabling to individually identify each vehicle 50. The usage request information includes schedule information such as a usage plan concerning usage of the vehicle 50, and a business identification information as requester identification information capable of identifying a business. The communication unit 21 transmits, to the vehicle 50, various kinds of information such as availability information, and instruction information for controlling the vehicle 50. Further, when the management server 20 is connected to the network 11 different from the networks 12, 13, and 14, the management server 20 and the business servers 40A to 400 can be configured such that information cannot be mutually exchanged. Note that, depending on the setting of the communication unit 21 and the network 11, all or a part of the information owned and managed by the management server 20 can be shared with the business servers 40A to 40C or the user terminal device 70, and predetermined information can be exchanged between the management server 20 and the business servers 40A to 40C or the user terminal device 70.

Specifically, the vehicle management control unit 22 includes a processor (not illustrated) such as a central processing unit (CPU), a digital signal processor (DSP), and a field-programmable gate array (FPGA), and a main storage unit (also not illustrated) such as a random access memory (RAM) and a read only memory (ROM). The storage unit 23 includes a storage medium selected from an erasable programmable ROM (EPROM), a hard disk drive (HDD), a removable medium and the like. Note that the removable medium is a disk recording medium such as a universal serial bus (USB) memory, a compact disc (CD), a digital versatile disc (DVD), and a Blu-ray (registered trademark) disc (BD). The storage unit 23 can store an operating system (OS), various programs, various tables, various databases, and the like. The vehicle management control unit 22 loads and executes the program stored in the storage unit 23 in the work area of the main storage unit, and controls each component or the like through the execution of the program, thereby achieving a function conforming to a predetermined purpose. In the present embodiment, the vehicle management control unit 22 can achieve functions of an availability determination unit 24 and a vehicle operation management unit 25 through the execution of the program.

The storage unit 23 includes a vehicle management database 23a and a usage status management database 23b in which various kinds of data are stored in a searchable manner. The vehicle management database 23a and the usage status management database 23b are, for example, relational databases (RDBs). Note that a database (DB) to be described below is constructed in such a manner that a program of a database management system (DBMS) executed by the processor described above manages data stored in the storage unit.

In the vehicle management database 23a, the vehicle identification information, the operation information and the like that are associated with each other are stored in a searchable manner. In the usage status management database 23b, the vehicle identification information is associated with the availability information and the usage request information related to usage of the vehicle 50, which are stored in a searchable manner. The vehicle identification information is stored in the vehicle management database 23a and the usage status management database 23b in a searchable state when it is assigned to the vehicle 50. The vehicle identification information includes various types of information for identifying individual vehicle 50 from each other. When the vehicle 50 transmits, to the management server 20, information such as the positional information and the vehicle information together with the vehicle identification information, the management server 20 associates the received information with the vehicle identification information, and stores it in the vehicle management database 23a in a searchable state. Likewise, when the vehicle 50 transmits, to the management server 20, information such as the usage request information and the availability information together with the vehicle identification information, the management server 20 associates the received information with the vehicle identification information, and stores it in the usage status management database 23b in a searchable state.

In the present embodiment, the vehicle management control unit 22 can achieve functions of the availability determination unit 24 and the vehicle operation management unit 25 through the execution of the program described above. The availability determination unit 24 determines, according to the determination request information received from a predetermined vehicle 50, availability of use of the vehicle 50 on the basis of a previous usage status of the predetermined vehicle 50, initial setting information set by an owner, an administrator or the like of the vehicle 50, and the like. A determination result of the availability of use of the vehicle 50 is transmitted to, as availability result information, the predetermined vehicle 50 through the communication unit 21. The vehicle operation management unit 25 collects information such as the vehicle information, the operation information, the usage request information, and the availability information received from each vehicle 50, and stores the information in the vehicle management database 23a and the usage status management database 23b.

Business Server

The business servers 40A, 40B, and 40C execute processing of reserving the vehicle 50 having a communication function and managing a schedule for providing a user with a predetermined service using the vehicle 50. Note that, in the following descriptions, the business servers 40A to 40C may be collectively referred to as a business server 40 or the like instead of being individually described, and the same applies to their components. In addition, although the number of the business servers 40A to 40C is three in the present embodiment, it is not limited to three. The business server 40 receives the availability information from the vehicle 50, and receives various types of information from the user terminal device 70. The business server 40 transmits the usage request information to the vehicle 50.

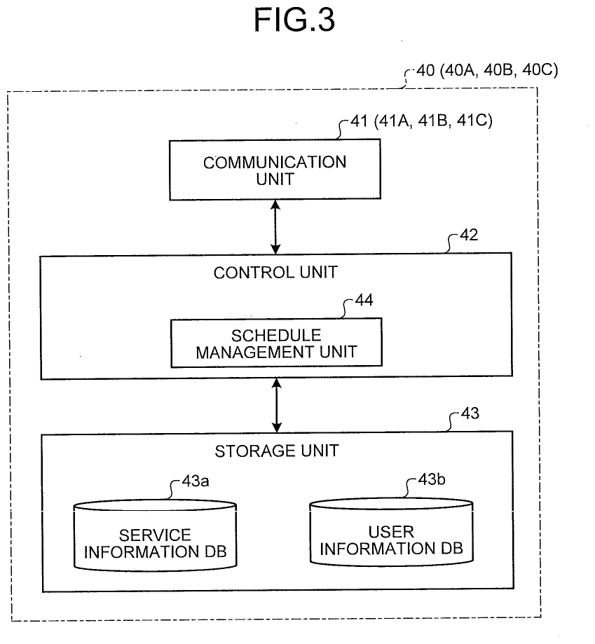

FIG. 3 is a block diagram schematically illustrating a configuration of the business server 40. As illustrated in FIG. 3, the business server 40 has a general computer configuration that can communicate via the network 10. The business server 40 includes a communication unit 41, a control unit 42 including a schedule management unit 44, and a storage unit 43.

The communication unit 41 is physically similar to the communication unit 21 described above. The communication unit 41 is connected to the network 10, and communicates with the vehicle 50 and the user terminal device 70. The communication unit 41 associates, with the vehicle 50, the business identification information and the usage request information of a business that requests the use of the vehicle 50 to transmit the information, and receives the availability information from the vehicle 50. The usage request information includes information necessary for using the vehicle 50, such as the vehicle identification information, a time zone for use, and a location of use of the vehicle 50 to be used, and information regarding a type of a service provided by a business and the business identification information. The availability information is permission information for permitting the use of the vehicle 50, or non-permission information for not permitting the use of the vehicle 50. The communication unit 41 communicates with the user terminal device 70 in such a manner that it transmits information to the user terminal device 70 owned by the user at the time of using the vehicle 50 and it receives, from the user terminal device 70, user identification information for identifying the user and various kinds of information.

Specifically, a communication unit 41A of the business server 40A is connected to the network 12. A communication unit 41B of the business server 40B is connected to the network 13. A communication unit 41C of the business server 40C is connected to the network 14. In this case, the business servers 40A to 40C can be configured not to share or exchange information with each other. Note that, according to the setting of the communication units 41A to 41C and the networks 12 to 14, all of or a part of the information owned and managed by the business servers 40A to 40C may be shared with each other, or predetermined information may be exchanged.

The control unit 42 and the storage unit 43 are physically similar to the vehicle management control unit 22 and the storage unit 23 described above, respectively. The storage unit 43 stores a service information database 43a, and a user information database 43b. In the service information database 43a, the vehicle identification information of the vehicle 50 and various kinds of information such as schedule information regarding the vehicle 50 to be used when the service to be provided by the business is provided to the user, which are associated with each other, are stored in a searchable manner. The user information database 43b stores various kinds of information necessary for using the vehicle 50 input or selected by the user who uses the service provided by the business or enjoying the provided service (hereinafter also referred to as user selection information) and the like that are associated with the user identification information. The various kinds of information such as the user selection information is stored in the user information database 43b in a searchable state and is updated in a case where, for example, the user applies for or uses a predetermined service provided by the business. In addition, the various kinds of information associated with the user may include, for example, credit information obtained by quantifying credit of the user, usage status information associated with driving behavior and usage status of the user when the user uses the vehicle 50, third party evaluation information indicating evaluation of the user made by a third party, and the like. Note that the user information database 43b is not limited to the case of being included in the business server 40. That is, the user information database 43b may be included in another server (not illustrated) other than the business server 40, and the user information database 43b stored in the other server may be accessed via the network 10 as necessary.

Vehicle

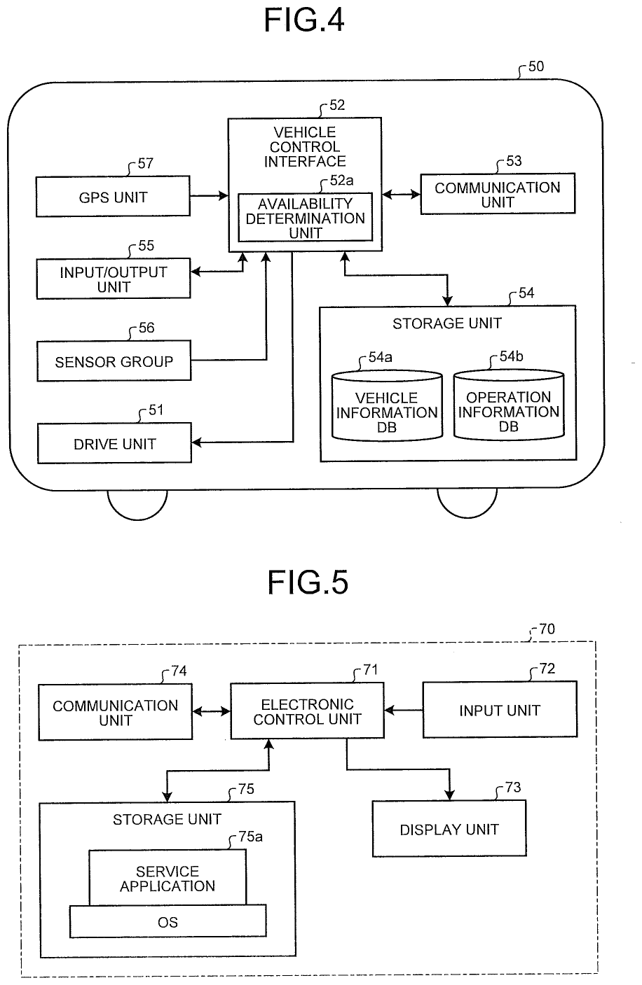

The vehicle 50 as a moving object is a vehicle that travels by driving of a driver, or an autonomous traveling vehicle capable of traveling autonomously in accordance with a given operational command. FIG. 4 is a block diagram schematically illustrating a configuration of the vehicle 50. As illustrated in FIG. 4, the vehicle 50 includes a drive unit 51, the vehicle control interface 52, the communication unit 53, a storage unit 54, an input/output unit 55, a sensor group 56, and a GPS unit 57.

The drive unit 51 is a known drive unit necessary for traveling of the vehicle 50. Specifically, the vehicle 50 includes an engine and a motor as a drive source. The engine is capable of generating power according to driving based on fuel combustion using an electric motor or the like. The generated power is charged in a rechargeable battery. Furthermore, the vehicle 50 includes a drive transmission mechanism for transmitting a driving force of the engine and the motor, a drive wheel for traveling, and the like.

The vehicle control interface 52 and the storage unit 54 are physically similar to the vehicle management control unit 22 and the storage unit 23 described above, respectively. The vehicle control interface 52 centrally controls operation of various components included in the vehicle 50. The vehicle control interface 52 may include an availability determination unit 52a similar to the availability determination unit 24 in the management server 20.

The communication unit 53 includes, for example, a data communication module (DCM) or the like that communicates with the management server 20 and the business server 40 by wireless communication via the network 10. The storage unit 54 includes a vehicle information database 54a, and an operation information database 54b. The vehicle information database 54a stores various kinds of information including a battery charge amount, a fuel remaining amount, the current position and the like in an updatable manner. The operation information database 54b stores various kinds of information including the schedule information provided by the business server 40 in an updatable manner.

The input/output unit 55 includes a touch panel display, a speaker microphone and the like. The input/output unit 55 as an output means is capable of making notification of predetermined information to the outside in accordance with control of the vehicle control interface 52, such as displaying characters and figures on the screen of the touch panel display, and outputting voice from the speaker microphone. Moreover, the input/output unit 55 as an input means inputs predetermined information to the vehicle control interface 52 by the user or the like by operating the touch panel display or uttering voice toward the speaker microphone.

The sensor group 56 includes a vehicle speed sensor, a sensor associated with traveling of the vehicle 50 such as an acceleration sensor, a vehicle interior sensor capable of detecting various conditions in the vehicle interior, for example, an imaging device such as an imaging camera and the like. The GPS unit 57 receives radio waves from a global positioning system (GPS) satellite (not illustrated), and detects the position of the vehicle 50. The detected position is stored in the vehicle information database 54a in a searchable manner as the positional information in the vehicle information. Note that a method in which light detection and ranging/laser imaging detection and ranging (LiDAR) is combined with a three-dimensional digital map may be adopted as a method of detecting a position of the vehicle 50.

User Terminal Device

The user terminal device 70 as a use terminal is operated by the user. The user terminal device 70 transmits various kinds of information such as user information including the user identification information and the user selection information to the management server 20 by, for example, a call using various kinds of data or voice performed by a communication application. The user terminal device 70 is capable of receiving, from the business server 40, various kinds of information such as the schedule information for using a service provided by the business, the vehicle identification information, and data of an electronic key. FIG. 5 is a block diagram schematically illustrating a configuration of the user terminal device 70.

As illustrated in FIG. 5, the user terminal device 70 includes an electronic control unit 71, an input unit 72, a display unit 73, a communication unit 74, and a storage unit 75, which are communicably connected to each other. The electronic control unit 71, the communication unit 74, and the storage unit 75 are physically similar to the vehicle management control unit 22, the communication unit 21, and the storage unit 23 described above, respectively. The electronic control unit 71 executes various application programs to centrally control operation of the input unit 72, the display unit 73, the communication unit 74, and the storage unit 75. The communication unit 74 exchanges various kinds of information, such as the user identification information, the user selection information, and voice data, with an external server such as the business server 40 via the network 10. The storage unit 75 is capable of storing the user identification information. In the storage unit 75, a service application 75a for using the service provided by the business is installed with the OS serving as a basic application.

The input unit 72 includes, for example, a keyboard, a touch panel keyboard incorporated in the display unit 73 to detect touch operation on the display panel, or an audio input device that enables a call with the outside. Here, the call with the outside includes not only a call with another user terminal device 70 but also a call with an operator who stands by at the management server 20 or an artificial intelligence system, for example. The display unit 73 includes, for example, an organic electro-luminescence (EL) panel, or a liquid crystal display panel, and displays characters, figures and the like on the display panel to make notification of information to the outside. Note that the input unit 72 and the display unit 73 may be configured similar to the input/output unit 55 described above.

Specifically, a mobile phone such as a smartphone, an information terminal such as a tablet, a personal computer or the like can be adopted as the user terminal device 70 described above. Note that a desktop personal computer installed at home or the like, a fixed telephone installed at home or the like, etc. can also be used.

Method of Managing Usage

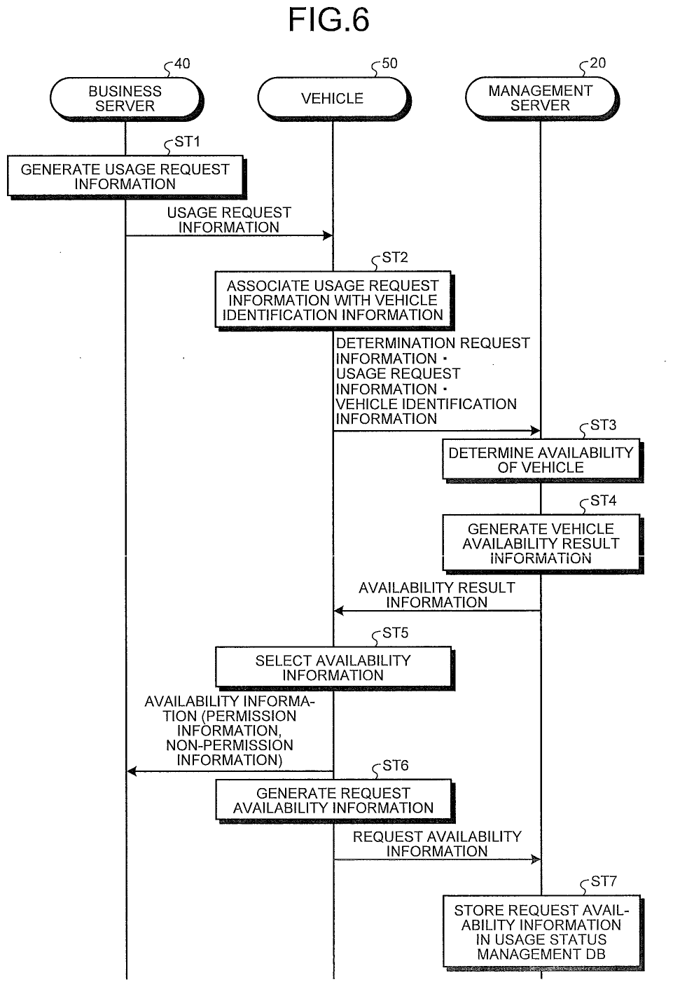

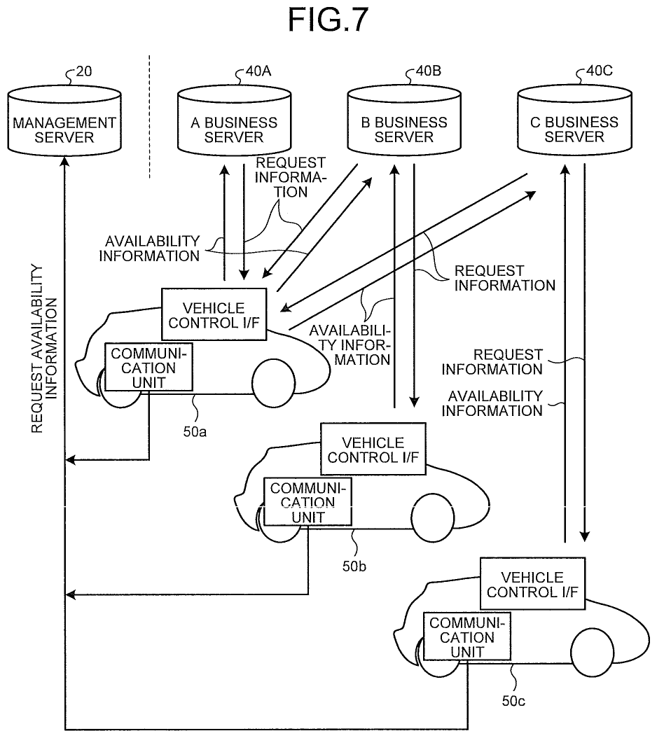

Next, a method of managing usage executed in the usage management system 1 configured as described above will be described. Note that, while transmission and reception of information are performed via the networks 11 to 14 in the following descriptions, description on this point will be omitted. FIGS. 6 and 7 are a flowchart and a schematic diagram for illustrating a method of managing usage according to the embodiment, respectively. The following descriptions will be made corresponding to the flowchart of FIG. 7 with appropriate reference to FIG. 6.

That is, as illustrated in FIG. 6, the schedule management unit 44 of the business server 40 generates the usage request information based on the service provided by the business in step ST1. As described above, the usage request information includes information necessary for using the vehicle 50, such as the vehicle identification information, a time zone for use, and a location of use of the vehicle 50 to be used, and information regarding a type of the service provided by the business and the business identification information. The schedule management unit 44 transmits the generated usage request information to the predetermined vehicle 50 scheduled to be used through the communication unit 41. For example, in the example illustrated in FIG. 7, each of the A business server 40A, the B business server 40B, and the C business server 40C transmits the usage request information to a vehicle 50a. The B business server 40B further transmits the usage request information to a vehicle 50b. Likewise, the C business server 40C further transmits the usage request information to a vehicle 50c.

Next, in step ST2 of FIG. 6, the vehicle control interface 52 of the vehicle 50 associates the received usage request information with the vehicle identification information. The vehicle control interface 52 transmits the usage request information, the vehicle identification information, and the determination request information to the management server 20 through the communication unit 53. The determination request information is information for requesting the management server 20 to determine availability with respect to the usage request information received by the vehicle 50.

Next, in step ST3, the availability determination unit 24 of the management server 20 reads out necessary information from the vehicle management database 23a and the usage status management database 23b in response to the received determination request information, and analyzes the received usage request information to determine availability of the vehicle 50. Subsequently, in step ST4, the availability determination unit 24 generates availability result information on the basis of the determination result of the availability of the vehicle 50. The availability determination unit 24 transmits, through the communication unit 21, the generated availability result information to the vehicle 50 based on the vehicle identification information.

Note that, in a case where the vehicle control interface 52 of the vehicle 50 includes the availability determination unit 52a, a usage status management database (not illustrated) associated with the individual vehicle 50 may be constructed in the storage unit 54, and the availability determination unit 52a may determine the availability. That is, the availability determination unit 52a may read out necessary information from a vehicle usage status database, the vehicle information database 54a, and the operation information database 54b, analyze the received usage request information, and determine the availability of the vehicle 50. In that case, the availability determination unit 52a generates the availability result information.

Next, in step ST5, the vehicle control interface 52 selects the permission information or the non-permission information as the availability information on the basis of the received availability result information. That is, the vehicle control interface 52 selects the permission information as the availability information when the received availability result information is information for permitting the use of the vehicle 50, and selects the non-permission information when the received availability result information is information for not permitting the use of the vehicle 50. The vehicle control interface 52 transmits the selected availability information to the business server 40 that has transmitted the usage request information through the communication unit 53. For example, in the example illustrated in FIG. 7, the vehicle 50a transmits the availability information to each of the A business server 40A, the B business server 40B, and the C business server 40C. The vehicle 50b transmits the availability information to the B business server 40B. Likewise, the vehicle 50c transmits the availability information to the C business server 40C.

Note that the user who manages the vehicle 50 may select the permission information or the non-permission information in step ST5. In that case, after the vehicle 50 receives the usage request information, the input/output unit 55 of the vehicle 50 may make notification of the usage request information without steps ST3 and ST4 being executed, and the user may select permission or non-permission of the use. At this time, the vehicle control interface 52 may access the usage status management database 23b of the management server 20 and may read out necessary information from the vehicle information database 54a and the operation information database 54b so that various kinds of information may be notified by the input/output unit 55.

Next, in step ST6, the vehicle control interface 52 generates request availability information that includes the usage request information transmitted from the business server 40 and the availability result information transmitted from the management server 20 in association with each other. The request availability information is information in which the usage request information received by the vehicle 50 is associated with the availability information that is the permission information or the non-permission information transmitted by the vehicle 50. The vehicle control interface 52 transmits the generated request availability information to the management server 20 through the communication unit 53.

Next, in step ST7, the management server 20 that has received the request availability information stores the received request availability information in the usage status management database 23b in a searchable manner. Accordingly, information necessary for using the vehicle 50 that the business wishes to use, the business identification information, and information regarding the type of the service provided by the business, which are associated with the availability information of the vehicle 50 with respect to the usage request information, are stored in the usage status management database 23b of the management server 20.

Moreover, in the business server 40, when the permission information is received from the vehicle 50 after step ST5, the business that manages the business server 40 provides a service using the vehicle 50. For example, it is assumed a case where a service provided by the A business that manages the A business server 40A of FIG. 7 is a car sharing service, for example, and a service provided by the B business that manages the B business server 40B is a ridesharing service, for example. In that case, when a time zone for use of the vehicle 50a of the A business does not overlap with a time zone for use of the vehicle 50a of the B business and the vehicle 50a is at the location where it is deliverable between the A business and the B business, for example, the same vehicle 50a can be used for different services provided by the A business and the B business. Furthermore, in a case where a service provided by the C business that manages the C business server 40C is a home delivery service, for example, the trunk or the like of the vehicle 50a can be used as a delivery box while the user who owns the vehicle 50a or another business is not using the vehicle 50a.

In addition, it is assumed a case where, for example, the vehicle 50a is a vehicle managed by a leasing company, the A business is a business that provides an in-vehicle accommodation service using the vehicle 50a, and the C business is a business that provides a home delivery service. In that case, the same vehicle 50a can be used for providing the accommodation service by the A business at night, and can be used as a vehicle for delivering goods by the C business in time zones other than the night time zone.

Recording Medium

In the embodiment described above, a program capable of executing a method of managing a usage status can be recorded in a recording medium that can be read by a computer or other machines or devices (hereinafter referred to as a computer or the like). The computer or the like is caused to read and execute the program in the recording medium so that the computer functions as the management server 20. Here, the recording medium that can be read by the computer or the like indicates a non-transitory recording medium capable of storing information such as data and a program electrically, magnetically, optically, mechanically, or chemically, and can be read by the computer or the like. Examples of such a recording medium removable from the computer or the like include a memory card such as a flexible disk, a magneto-optical disc, a CD-ROM, a CD-R/W, a DVD, a BD, a digital audio tape (DAT), a magnet tape, and a flash memory. In addition, examples of the recording medium fixed to the computer or the like include a hard disk, a ROM and the like. Moreover, a solid state drive (SSD) can be used as a recording medium removable from the computer or the like, and also as a recording medium fixed to the computer or the like.

According to the embodiment of the present disclosure described above, in the management server 20, the usage request information for requesting the use of the vehicle 50 by the business providing the service is associated with the availability information including information regarding availability of the vehicle 50, and can be stored and managed in the usage status management database 23b. Accordingly, the vehicle 50 can be used as what is called a network hub that combines the usage request information with the availability information and exchanges information between the management server 20 and the business server 40. Furthermore, even when each of a plurality of businesses providing a predetermined service requests the use of the same vehicle 50, the usage status of the vehicle 50 can be appropriately managed in a collective manner.

Moreover, the usage request information and the availability information are associated with each other and stored in the usage status management database 23b as the request availability information. Here, in the management server 20, the usage status management database 23b can be set to be accessible from each of the business servers 40A to 40C and the user terminal device 70, for example, so that the request availability information can be set to be accessible. In that case, schedule management in various services using a moving object including a service in which an application programming interface (API) or the like is not disclosed can be executed by one application. Note that information such as the request availability information stored in the usage status management database 23b can be sold for profit.

While the embodiment of the present disclosure has been specifically described above, the present disclosure is not limited to the embodiment described above, and various modifications may be made on the basis of the technical ideas of the present disclosure. For example, the configuration of the server, the type of the information, and the type of the business mentioned in the embodiment described above are merely examples, and may be a configuration of the server, a type of the information, and a type of the business different from those mentioned above as necessary.

For example, although the management server 20 is a single server in the embodiment described above, the management server 20 may be a plurality of separate servers that can communicate with each other. Specifically, the usage status management database 23b of the storage unit 23 in the management server 20 may be stored in another data server, for example. Further, the management server 20 may store various kinds of information previously collected through the network 10 as a database including, for example, big data. Furthermore, various kinds of information may be collected from each user terminal device 70.

For example, although a car sharing service, a ride share service, and a trunk have been described as examples of the service in the embodiment described above, various services can be adopted as long as it is a service using a moving object. Specifically, it is possible to adopt a service such as a car rental service, an unmanned air vehicle rental service, a stay-type vehicle rental service, and an autonomous vehicle rental service. Moreover, the present disclosure can also be applied to a bicycle sharing service, an aircraft rental service, and the like.

For example, in the embodiment described above, any one of the functional components of the management server 20 or a part of the processing thereof may be executed by another computer connected to the network 11. Furthermore, the series of processing executed by the management server 20 can be executed not only by hardware but also by software.

According to the usage management device, the method of managing usage, and the recording medium storing he program according to the present disclosure, the request for use of the moving object made by the requester and the availability of the moving object can be associated with each other and managed, whereby the usage status of the moving object can be appropriately managed when each of a plurality of requesters that provides a predetermined service requests use of the same moving object.

According to an embodiment, it becomes possible to, for each moving object, collectively manage information as to which requester each moving object is permitted to use, and which service each moving object is permitted to use.

According to an embodiment, it becomes possible to understand a request for use of the moving object made by a business that provides a predetermined service and a response regarding availability from the moving object to the predetermined business, whereby the usage status and the availability of the moving object can be managed more appropriately.

According to an embodiment, in a business that provides a service using a vehicle, such as a car sharing service, a car rental service, and a ride share service, it becomes possible to collectively manage requests for use of the vehicle and answers from the vehicle in response to the requests.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A usage management device, comprising:
a control unit configured to
receive usage request information and availability information from a moving object which communicates with outside, the usage request information being for requesting a use of the moving object and being transmitted from a requester, who provides a service using the moving object, to the moving object, the availability information including information which indicates permission or non-permission of the use of the moving object and is transmitted from the moving object to the requester on a basis of the usage request information, and
store the usage request information and the availability information in association with each other in a storage unit.

2. The usage management device according to claim 1, wherein
the usage request information includes moving object identification information to identify the moving object, requester identification information to identify the requester, and information associated with a service provided by the requester.

3. The usage management device according to claim 1, wherein
the requester includes a business who provides a service using the moving object.

4. The usage management device according to claim 1, wherein
the moving object is a vehicle.

5. A method of managing usage performed by a usage management device that manages a usage status of a moving object which communicates with outside, the method comprising:
receiving usage request information and availability information from the moving object, the usage request information being for requesting a use of the moving object and being transmitted from a requester, who provides a service using the moving object, the availability information including information which indicates permission or non-permission of the use of the moving object and is transmitted from the moving object to the requester on a basis of the usage request information; and
storing, in a storage unit, the usage request information and the availability information in association with each other.

6. A non-transitory computer readable recording medium storing a program for causing a computer to manage a usage status of a moving object which communicates with outside, the program causing a computer to execute functions of:
receiving usage request information and availability information from the moving object, the usage request information being for requesting a use of the moving object and being transmitted from a requester, who provides a service using the moving object, the availability information including information which indicates permission or non-permission of the use of the moving object and is transmitted from the moving object to the requester on a basis of the usage request information; and
storing, in a storage unit, the usage request information and the availability information in association with each other.
